(19) United States
(12) Patent Application Publication
(10) Pub. No.: US 2023/0047661 A1
(43) Pub. Date: Feb. 16, 2023

(54) MULTIFUNCTIONAL COATING SYSTEM AND COATING METHOD FOR EROSION RESISTANCE AND PASSIVE EMISSIVITY IN SPACE ENVIRONMENTS

(71) Applicant: Faraday Technology, Inc., Englewood, OH (US)

(72) Inventors: Rajeswaran Radhakrishnan, Beavercreek, OH (US); Danny Xin Liu, Tipp City, OH (US); Dan Wang, Dublin, OH (US); Timothy D. Hall, Englewood, OH (US); Maria E. Inman, Yellow Springs, OH (US)

(21) Appl. No.: 17/716,621

(22) Filed: Apr. 8, 2022

Related U.S. Application Data
(60) Provisional application No. 63/231,923, filed on Aug. 11, 2021.

(51) Int. Cl. C25D 15/00; C09D 5/44

(52) U.S. Cl. CPC C25D 15/00; C09D 5/44

(57) ABSTRACT

A method of coating a substrate includes adding ion erosion resistant particles, conductive particles, and a binder to an electrophoretic solution in an electrophoretic deposition apparatus including the substrate and a cathode spaced from the substrate. A current is applied to the substrate and cathode to deposit a first layer coating including the erosion resistant particles, the conductive particles, and the binder onto the substrate. The method further includes adding a low work function material to an electrolyte solution in an electrolytic deposition apparatus including the substrate and a cathode spaced from the substrate. A current is applied to the substrate and the cathode to deposit a second layer coating including the low work function material onto the substrate.

### GOVERNMENT RIGHTS

This invention was made with U.S. Government support under Contract Nos. FA9453-19-P-0573 awarded by the United States Air Force and 80NSSC20C0287 awarded by NASA Shared Services Center (NSSC). The Government has certain rights in the subject invention.

### RELATED APPLICATIONS

This application claims benefit of and priority to U.S. Provisional Application Serial No. 63/231,923 filed Aug. 11, 2021, under 35 U.S.C. §§119, 120, 363, 365, and 37 C.F.R. §1.55 and §1.78, which is incorporated herein by this reference.

### FIELD OF THE INVENTION

This subject disclosure relates to a coating and coating deposition method for ion erosion resistance and passive electron emission during space weather exposure of spacecraft components, satellites, orbiting platforms, solar arrays and the like.

### BACKGROUND OF THE INVENTION

Much like terrestrial weather, space weather results from a complex system driven both by the Sun and events much closer to Earth. The Sun’s constant outflow of solar wind fills space with a thin and tenuous wash of particles, fields and plasma. This solar wind, along with other solar events like giant explosions called coronal mass ejections, influences the very nature of space and can interact with the magnetic systems of Earth. These effects change the radiation environment through which spacecraft, satellites, orbiting platforms, solar arrays and the like are exposed. Space weather can interfere with satellite electronics, communications and GPS signals, and in extreme cases utility grids on Earth.

A National Space Weather Strategy and Action plan seeks to “enhance the Protection of National Security, Homeland Security, and Commercial Assets and Operations against the Effects of Space Weather”. Any naturally occurring space phenomena that has the potential to disrupt the critical functions of systems operating in space or on Earth, can be considered space weather. Many space weather events can lead to the cascading degradation of systems operating within low-earth (LEO) or geosynchronous (GEO) orbit such that key services such as communications, remote sensing, and environmental monitoring can be critically limited. Extreme space weather events like solar flares, cosmic rays, and radiation belts cause ionizing radiation that can damage electronics, solar arrays, and optical systems on satellites reducing their functionality and lifetimes. Ionic radiation causes atoms to ionize and eject their electrons from their outer shells thus forming a charged plasma. This plasma is created during space weather events or when spacecraft fly in and out of the ionosphere, thus inducing an ionic charge on the spacecraft’s surface. This negative charge buildup can lead to ion sputtering, arcing, and parasitic currents producing irreparable damage in solar arrays.

Many attempts have been made to mitigate spacecraft charging, including: 1) metallic coatings, 2) system chassis ground leads to as many surfaces as possible, and 3) choosing surface materials with high secondary electron emission by electron impact. See Ryschkewitsch, M.G., NASA HDBK-4002A, 2011, Mitigating In Space Charging Effects-A Guideline and Scolese, C. J., NASA HDBK-4006, 2007, Low Earth Orbit Spacecraft Charging Design Handbook. However, these techniques are not completely effective in severe sub-storm conditions. See Matéo-Vélez, J-C, et al., IEEE Trans on Plasma Science, 43(9), 2015, 2839; Lai, S., Overview on spacecraft charging mitigation methods. IEEE Trans Plasma Sci, 31(6) 1118, 2003; and Garrett. H. B., Charging of Spacecraft Surfaces. Reviews Geophysics Space Physics 19, 1981, 577. Alternative solutions for charge alleviation, including leveraging passive, autonomous electron emission have been proposed. See Iwata, M., J. Spacecraft and Rockets, 49(3), May-June 2012; Khan. A.R., IEEE Trails. Plasma Sci.. 40(2) 380-387, February 2012; Cooke, D., Introducing Passive Anode Surface Emission Cathode, 38th AIAA/ASME/SAE/ASEE Joint Propulsion Conference&Exhibit, AIAA Paper 2002-4049, Indianapolis, IN, 2002; and Zhang H. et al., J. Phys. Chem. B, 117, 6, 2013, pp 1616-1627.

In addition to space weather, spacecraft components, satellites, orbiting platforms, solar arrays and the like are subjected to the impingement of atomic oxygen. Atomic oxygen is particularly prevalent for orbiting platforms in LEO and entering into and out of the Earth’s atmosphere. Atomic oxygen erodes the surfaces of spacecraft components, satellites, orbiting platforms, solar arrays and the like. While thicker surfaces may be employed, the disadvantage associated with the increased weight of the space vehicle and associated increased launch cost does not provide sufficient benefit.

U.S. Pat. No. 10,184,050, incorporated herein by this reference, discloses a coating consisting of carbon nanotubes and a binder to provide atomic oxygen shielding and other properties. However, the coating disclosed does not provide both erosion resistance and protection from the adverse effects of spacecraft charging.

U.S. Patent Application No. 20050230560A1, also incorporated herein by this reference, discloses an electrostatic dissipative surface based on a layer of carbon nanotubes and a polymeric material. While the layer is effective for electrostatic discharge, the problem of erosion is not addressed.

### BRIEF SUMMARY OF THE INVENTION

The application of materials systems onto spacecraft components that can passively mitigate the negative charge build up by emitting the electron back into space, while improving durability/resistance to ion erosion, are desired.

A need continues for a multifunctional coating system and coating method which combines passive electron emission and erosion resistance to mitigate the adverse effects of space weather and the space environment on spacecraft components, satellites, orbiting platforms, solar arrays and the like. Thus, the local application of materials systems onto spacecraft components, satellites, orbiting platforms, solar arrays and the like that can passively mitigate the negative charge build up by emitting the electrons back into space while improving durability/resistance to ion erosion are desired.

The problems of charging and erosion of spacecraft components brought on by space weather events and ionizing radiation are solved, in one embodiment, by an ion -erosion resistant coating including some combination of: 1) an erosion resistant material, such as boron-doped diamond particles. 2) an electronically conducting material, such as graphene, carbon nanotubes (CNTs), carbon black materials and the like, and 3) a low work function material to provide passive electron emissivity, such as lithium. CaB₆, CeB₆, LaB_{6,} and the like, deposited approximately uniformly across planar and nonplanar surfaces using a pulse/pulse reverse electrolytic and electrophoretic deposition process.

In one preferred embodiment, a multifunctional coating system for mitigating adverse effects of exposure to space weather and space environment comprises an erosion resistant material, a low work function material, and an electronically conducting material. A binder could be included in the coating system. The erosion resistant material may comprise boron-doped diamond particles. The low work function material may include lithium, calcium hexaboride, cerium hexaboride, and/or lanthanum hexaboride. The electrically conducting material may include graphene, carbon black, and/or carbon nanotubes.

In one preferred embodiment, a multifunctional coating system for mitigating adverse effects of exposure to space weather and space environment is applied to selected surfaces of spacecraft components, satellites, or orbiting platforms. The multifunctional coating system for mitigating adverse effects of exposure to space weather and space environment can be applied to selected surfaces of solar arrays.

The coating deposition method can be based on a pulse current or pulse reverse current electrophoretic deposition process from an electrolyte bath containing a specified concentration of erosion resistant materials and conducting materials and low work function materials. The coating deposition method may be based on a pulse current or pulse reverse current electrolytic deposition process from an electrolyte bath containing a specified concentration of erosion resistant materials and conducting materials and low work function materials. In one preferred embodiment, the pulse current or pulse reverse current coating deposition method is tuned to provide a uniform distribution of the multifunctional coating system across the surface of interest. In one preferred embodiment, the pulse current or pulse reverse current coating deposition method is tuned to provide a localized application of the multifunctional coating system on a specific location on the surface of interest. The pulse current or pulse reverse current coating deposition method is preferably tuned to provide a uniformly distributed mixture of the components within the multifunctional coating system to the surface of interest. The pulse current or pulse reverse current coating deposition method is preferably tuned to provide a compositionally graded distribution of the components within the multifunctional coating system to the surface of interest. The pulse current or pulse reverse current coating deposition method may be tuned to provide one or more layers within the multifunctional coating system to the surface of interest.

Aluminum substrates in the form of flat coupons have been coated with various combinations and layer structures of boron-doped diamond, graphene, and low work function materials (such as lithium. CaB₆, CeB₆, LaB₆). Flat coupons coated with a boron-doped diamond/graphene mixture with Li enhancements were tested in a relevant environment and demonstrated a 140% increase in the maximum (Emax) total electron yield (TEY) over the uncoated A1 substrate sample, as well as an extended range of electron yields between crossover energies above 1 by approximately 4 times, as well as maintenance of nominal emission properties through ion erosion of modeled ISS plasma erosion conditions at a low-density (10⁶ /cm³), low-temperature (≤1-eVelectron temperature) plasma for 60±1 min with an approximate 30% duty cycle. A coating of graphene with lithium decoration achieved a 290% increase in Total Electron Yield, and a 9 times increase in the range of electron energies above a Total Electron Yield of 1.

The subject invention, however, in other embodiments, need not achieve all these objectives and the claims hereof should not be limited to structures or methods capable of achieving these objectives.

Aside from the preferred embodiments disclosed herein, this invention is capable of other embodiments and of being practiced or being carried out in various ways. Thus, it is to be understood that the invention is not limited in its application to the details set forth in the following description or illustrated in the drawings. Moreover, the claims are not to be read restrictively unless there is clear and convincing evidence manifesting in certain exclusion, restriction, or disclaimer.

Featured is a method of coating a substrate. The method comprises adding ion erosion resistant particles, conductive particles, and a binder to an electrophoretic solution in an electrophoretic deposition apparatus including the substrate and a cathode spaced from the substrate. A current is applied to the substrate and cathode to deposit a first layer coating including the erosion resistant particles, the conductive particles, and the binder onto the substrate. A low work function material is added to an electrolyte solution in an electrolytic deposition apparatus including the substrate and a cathode spaced from the substrate. A current is applied to the substrate and the cathode to deposit a second layer coating including the low work function material onto the substrate.

The erosion resistant particles can include boron doped diamond particles. The conductive particles may include graphene, carbon nanotubes, and/or carbon black. The low work function material may include lithium, calcium hexaboride, cerium hexaboride, and/or lanthanum hexaboride. The second layer coating may include the erosion resistant particles, the conductive particles, and the low work function material.

The method may further include removing any oxide on the substrate before placing the substrate in the electrophoretic deposition apparatus. In one example, the substrate is aluminum.

Also featured is a substrate coated with a two-layer coating. A first, electrophoretically deposited layer, includes ion erosion resistant particles, conductive particles, and a binder prevent ion erosion and to provide atomic oxygen shielding. A second, electrolytically deposited layer includes a low work function material to improve passive electron emissivity. The erosion resistant particles may include boron doped diamond particles, the conductive particles may include graphene, carbon nanotubes, and/or carbon black, and the low work function material may include lithium, calcium hexaboride, cerium hexaboride, and/or lanthanum hexaboride.

Also featured is a method of coating a substrate. An electrophoretic is employed process to deposit ion erosion resistant particles, conductive particles, and/or a low work function material onto a substrate and an electrolytic process is employed to deposit ion erosion resistant particles, conductive particles, a binder, and/or a low work function material onto the substrate.

The electrophoretic process can be carried out before the electrolytic process. In one example, the electrophoretic process is employed to deposit the ion erosion resistant particles, and the conductive particles, and the electrolytic process is employed to deposit the low work function material. A binder is usually included in the electrophoretic process.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic view of a multifunctional coating system with a mixture of erosion resistant, low work function and electronically conducting materials;

FIG. 2 is a schematic view of a multifunctional coating system where one or more of the component materials is layered;

FIG. 3 is a schematic view of a multifunctional coating system where one or more of the component materials is compositionally graded;

FIG. 4 is a schematic view of a locally deposited multifunctional coating system;

FIG. 5 is a schematic view of an example of an electrophoretic deposition process;

FIG. 6 is a representation of a generalized pulse/pulse reverse waveform;

FIG. 7 is a representation of a duplex pulsating boundary layer;

FIG. 8 is a representation of a macroprofile and a microprofile boundary layer under direct current and pulse current conditions:

FIG. 9 is a summary of guiding principles for the impact of pulse parameters on deposit distribution;

FIG. 10 is a flow diagram representation of an exemplary two-step coating deposition process;

FIG. 11 generally depicts an exemplary process line for a two-step coating deposition process;

FIG. 12 is the electron yield data for an aluminum substrate without a coating system:

FIG. 13 is the electron yield data for an aluminum substrate with a boron-doped diamond (BDD) coating system;

FIG. 14 is the electron yield data for an aluminum substrate with a lanthanum hexaboride coating system;

FIG. 15 is the electron yield data for an aluminum substrate with a cerium hexaboride coating system;

FIG. 16 is the electron yield data for an aluminum substrate with a calcium hexaboride coating system;

FIG. 17 is the electron yield data for an aluminum substrate with a two-layer coating system of boron-doped diamond with lithium;

FIG. 18 is the electron yield data for an aluminum substrate with a three-layer coating system of boron-doped diamond, graphene and lithium;

FIG. 19 is the electron yield data for an aluminum substrate with a two-layer coating system of graphene and lithium;

FIG. 20 is the electron yield data for an aluminum substrate with a two-layer coating system of boron-doped diamond, graphene and lithium; and

FIG. 21 is the electron yield data for an aluminum substrate with a two-layer coating system of boron-doped diamond, graphene and lithium before and after erosion exposure.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Provided in one example is a multi-functional coating system and coating deposition method for ion erosion resistance and passive electron emission for spacecraft components, satellites, orbiting platforms, and the like during space weather exposure during low-earth (LEO) and geosynchronous (GEO) orbits. The multi-functional coating system preferably comprises a combination of one or more erosion resistant materials, one or more low work function materials to provide passive electron emissivity, and one or more electrically conducting materials. The one or more erosion resistant materials provide the coating system with resistance to erosion encountered by spacecraft components, satellites, orbiting platforms, solar arrays and the like from the space environment. The one or more low work function materials provide the coating system with passive emission properties for protection of spacecraft components, satellites and orbiting platforms from space weather. The one or more electrically conducting materials distribute the charge within the coating system for passive emission from the spacecraft components, satellites, orbiting platforms, solar arrays and the like exposed to space weather and the space environment.

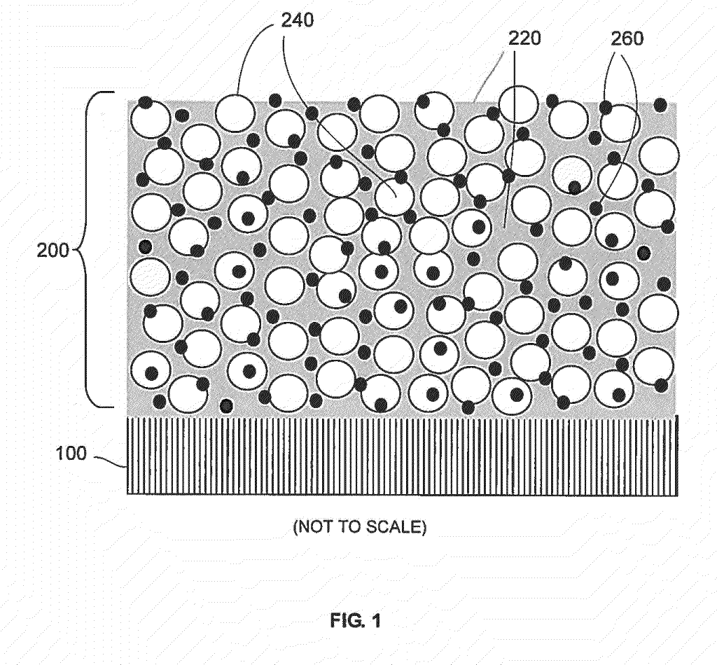

FIG. 1 depicts a multifunctional coating system 200 deposited on substrate 100. The substrate may be any suitable material used in spacecraft components, satellites, orbiting platforms, solar arrays and the like, such as aluminum alloy A96061 (Unified Numbering System). The multifunctional coating system 200 comprises a mixture of electrically conductive material 220, erosion resistant material 240, and low work function material 260. Not shown in FIG. 1 is the presence of a binder material, such as polyvinyl pyrrolidone (PVP). The electronically conducting material 220 may include graphene, carbon black, and/or carbon nanotubes. The erosion resistant material 240 may comprise boron doped diamond particles. By adjusting the coating deposition method as described herein, one or more of the electrically conductive material 220, erosion resistant material 240, and low work function material 260 is substantially uniformly dispersed as a mixture within the multifunctional coating system 200.

While not wishing to be bound by any particular theory, a relationship between electron emission and the work function of the material is presumed. Electrons in solid material are bound to the core atoms via the electrostatic force. The potential barrier induced by the electrostatic force is called the work function (W) for metals and the electronic affinity for dielectrics and semiconductors (x). To be emitted into the vacuum, electrons must overcome the material’s work function or electronic affinity.

The Fowler-Nordheim equation describes the emitted electron current density J_{FN} has been verified theoretically and experimentally:

$${J}_{F N} = \frac{{\text{c}}_{1} {\left({F}_{t i p}\right)}^{2}}{w} e x p \left[\frac{- {c}_{2} {w}^{3 / 2}}{{F}_{t i p}}\right]$$

where C1 and C2 are constants, W is the material work function, and Fₜᵢₚ = βE is the electric field amplified at the tip (E being the macroscopic field and β the geometrical amplification factor). The best emitter materials have the lowest W (or x). By including one or more low work function materials 260 in the multifunctional coating system 200, the passive electron emissivity is enhanced. With considerations of low work function and environmental stability, one or more low work function materials may include lithium, calcium hexaboride, cerium hexaboride, and/or lanthanum hexaboride.

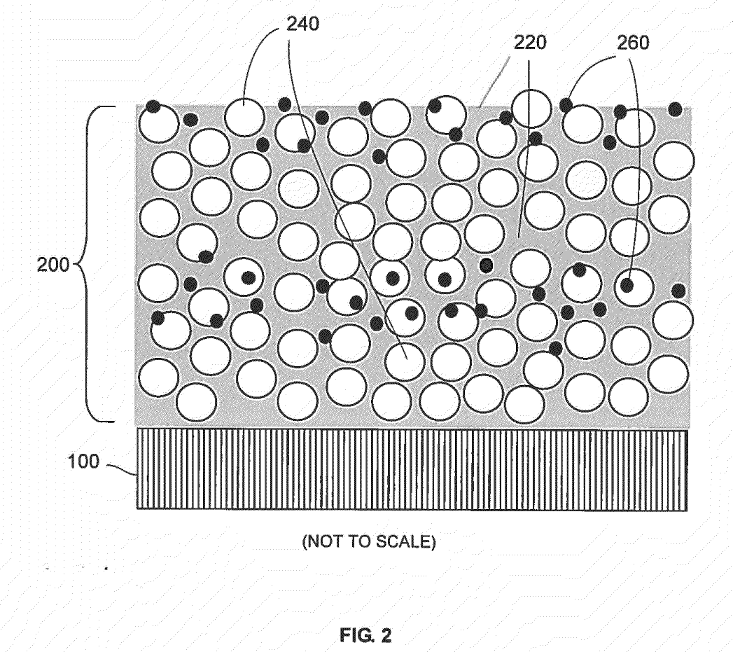

FIG. 2 depicts a multifunctional coating system 200 deposited on substrate 100. The multifunctional coating system 200 comprises a mixture of electrically conductive material 220, erosion resistant material 240, and low work function material 260. Not shown in FIG. 1 is the presence of a binder material, such as PVP. The electronically conducting material may include graphene, carbon black, and/or carbon nanotubes. The erosion resistant material preferably comprises boron doped diamond particles. The low work function material includes lithium, calcium hexaboride, cerium hexaboride, and/or lanthanum hexaboride. By adjusting the coating deposition method as described herein, one or more of the electrically conductive material 220, erosion resistant material 240, and/or low work function material 260 is layered within the multifunctional coating system 200. FIG. 2 illustrates layering of the low work function material 260.

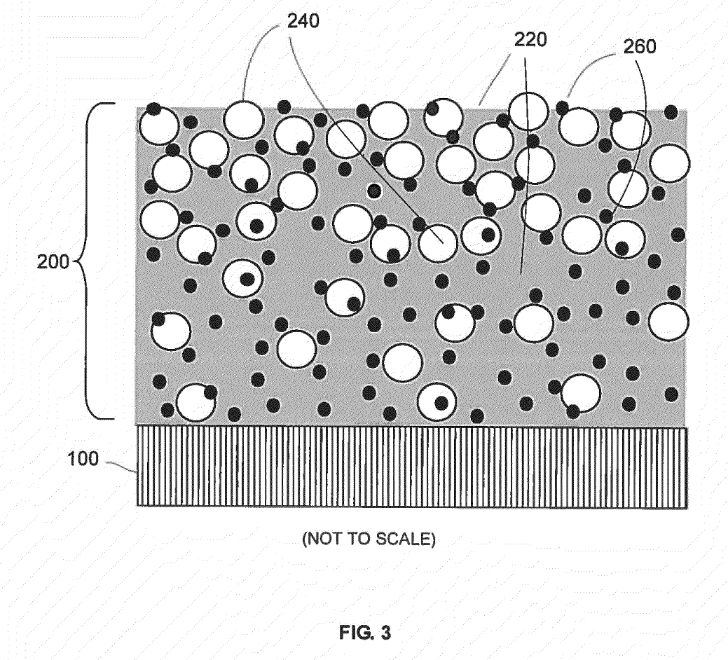

FIG. 3 depicts a multifunctional coating system 200 deposited on substrate 100. This coating system 200 comprises a mixture of electrically conductive material 220, erosion resistant material 240, and low work function material 260. Not shown is the presence of a binder material, such as PVP. By adjusting the coating deposition method as described herein, one or more of the electrically conductive material 220, erosion resistant material 240, and/or low work function material 260 is compositionally graded within the multifunctional coating system 200. FIG. 3 illustrates compositionally grading of the erosion resistant material 240.

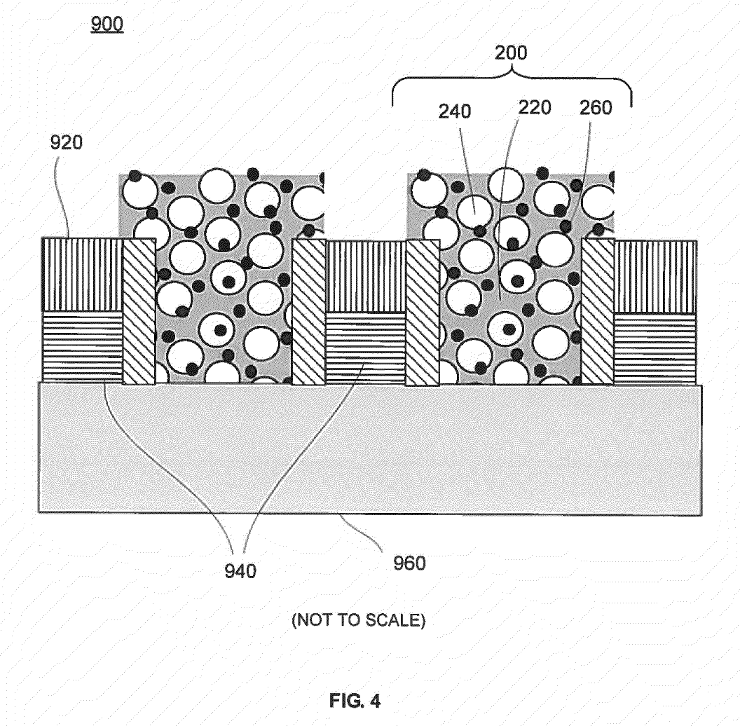

In FIG. 4 is a schematic representation of a localized multifunctional coating system 200 on a generalized solar array 900. A more detailed depiction of the solar array is described in U.S. Pat. No. 10,903,390 which is incorporated by reference. The solar array 900 generally comprises a doped cover glass 920 positioned over a photovoltaic cell 940 on an insulating substrate 960. The doped cover glass 920 and photovoltaic cell are in electrical contact with a conductor layer 980. The conductor layer 980 is coated with the multifunctional coating system to provide erosion resistance and passive electron emission for solar array 900.

Electrophoretic deposition includes the migration of small, suspended particles in a liquid driven by an electrical potential difference. Electrophoretic deposition is similar to electrolytic deposition, also known as plating, with the exception that the suspended particles do not undergo a valence change during deposition onto a substrate. Consequently, electrophoretic deposition has the benefits of fast deposition rates, non -line-of-sight deposition, simple deposition equipment, low levels of contamination, and reduction of waste. Electrophoretic deposition generally includes three steps: 1) particle charging in the suspension, 2) particle migration toward an oppositely charged substrate in the presence of an electric field, and 3) deposition of the particles onto the substrate. During electrophoretic deposition, two electrodes are immersed in a stable suspension of particles. With the application of an electric field, the charged particles in the suspension migrate towards the oppositely charged electrode where they are deposited. The migration velocity of spherical particles in suspension can be expressed as

$$V = \frac{2}{3} {ε}_{0} {ε}_{r} ζ {η}^{- 1} \left(d f / d x\right)$$

where ε₀ is the permittivity of vacuum, ε₁ is the relative permittivity of the solvent, ζ is the zeta potential of the particle, η is the viscosity of the solvent and df / dx represents the strength of the electric field. As evident from equation (2), the migration velocity of the particles in the suspension is a function of the applied electric field.

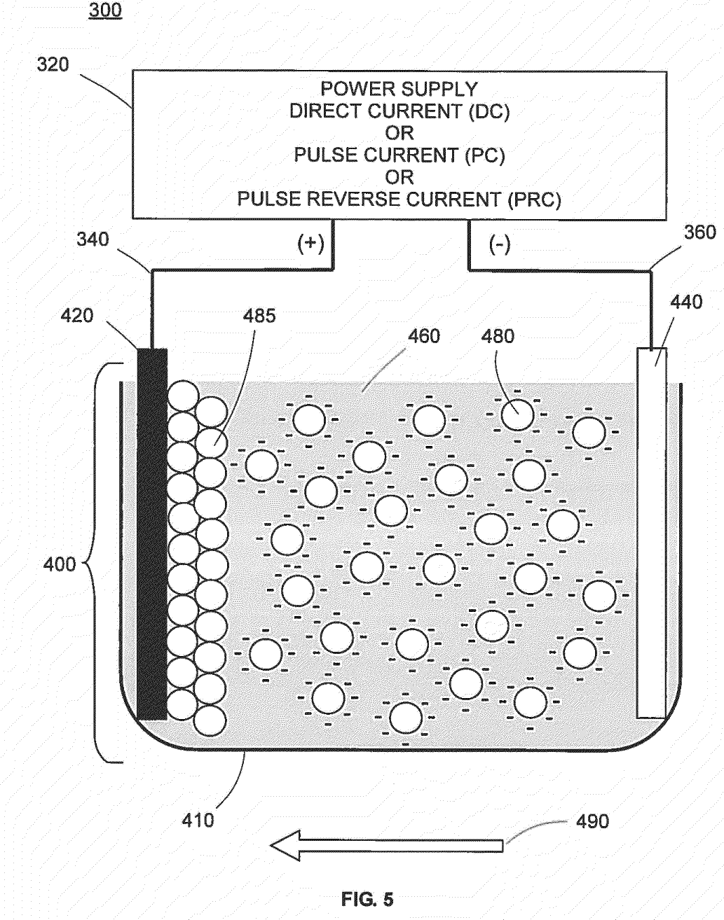

FIG. 5 is a schematic representation of an example of an electrophoretic deposition apparatus 300. Included is a power supply 320 with an anode lead 340 and a cathode lead 360 capable of delivering a direct current (DC), pulse current (PC) or pulse reverse current (PRC) to an electrophoretic cell 400. The electrophoretic cell 400 includes a cell container 410 with an anode 420, a cathode 440, and an electrophoretic solution 460 with one or more suspended particles 480. The suspended particles 480 develop a charge based on a number of factors such as material and solution 460 characteristics. FIG. 5 illustrates a negative charge on particles 480. However, the charge could be positive depending on solution 460 characteristics such as pH. Under the influence of the electric field from power supply 320, negatively charged particles are driven by an electrophoretic force 490 to the positive anode 420 and electrophoretically deposited as a layer 485. While not bound by theory, the charge on the layer 485 is neutralized by a binder in solution 460. Similarly, positively charged suspended particles would be driven to the cathode 440.

Electrolytic deposition or electrophoretic deposition may be practiced using direct current, pulse current or pulse reverse current. In direct current deposition processes, the current is applied to the electrolytic cell and generally held constant for a period of time, after which the deposit is formed on the oppositely charged electrode substrate. In pulse current/pulse reverse current electrolytic deposition, the current is interrupted and or reversed in predetermined ways. By properly selecting the pulse current/pulse reverse current waveform parameters, the deposit thickness, uniformity of deposition, localization of deposition, and properties are tuned for the specific application. Numerous embodiments of pulse current/pulse reverse current deposition are described by the common assignee of the instant invention in U.S. Pat. Nos. 6,080,504; 6,203,684; 6,210,555; 6,303,014; 6,309,528; 6,319.384; 6,524,461; 6,551,484; 6,652,727; 6,750,144; 6,827,833; 6,863,793; 6,878,259; 8,603,315; 10.100,423; and 10,684,522 which are incorporated herein by this reference.

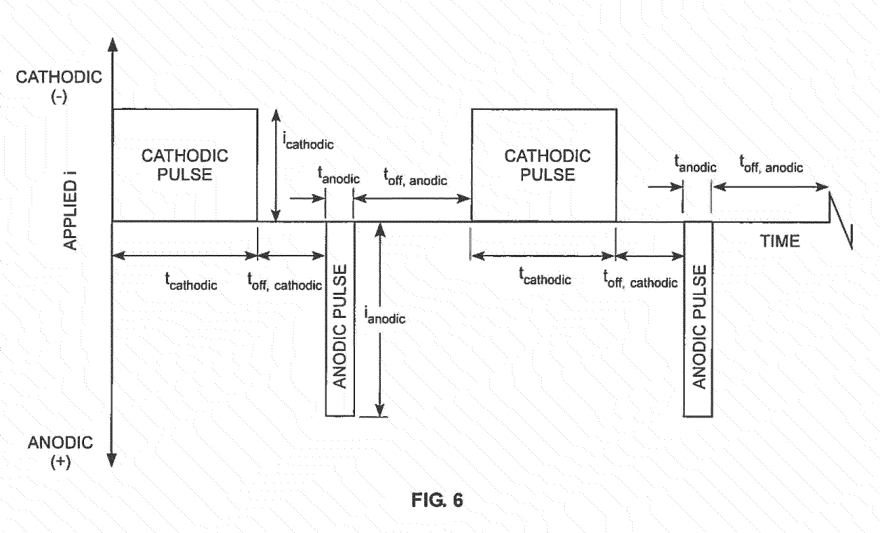

FIG. 6 represents a generalized pulse current/pulse reverse current waveform. The generalized waveform parameters are characterized by a cathodic pulse followed by an off-time and followed by an anodic pulse and followed by an off-time. One or both off-times may be eliminated and either the cathodic pulse or the anodic pulse may be eliminated. Furthermore, the waveform is generally net cathodic during electrolytic deposition. For electrophoretic deposition, the waveform is either net cathodic or net anodic to invoke the movement of positively charged or negatively charged particles towards the cathode or anode, respectively. The waveform parameters are: 1) anodic pulse current density, i_{anodic}, 2) anodic on-time, t_{on.anodic}, 3) cathodic pulse current density, i_{cathodic}, 4) cathodic on-time, tₒₙ_{.}_{c}_{athodic}, 5) cathodic off-timet_{off,} _{cathodi}_{c} and 6) anodic off-time, t_{off.}_{anodic}. The sum of the anodic and cathodic on-times and the off-time is the pulse period, T. The inverse of the pulse period is the frequency, f, of the pulse. The anodic, γₐ, and cathodic, γ_{c}, duty cycles are the ratios of the respective on-times to the pulse period. The average current density (iₐᵥₑᵣ) or net deposition rate is given by:

$${\text{i}}_{\text{aver}} = {\text{i}}_{\text{c}} {γ}_{\text{c}} = {\text{i}}_{\text{a}} {γ}_{\text{a}}$$

Just as there are many combinations of height, width, and length to obtain a given volume, in pulse processing there are many combinations of peak voltages/current densities, duty cycles, and frequencies to obtain a given deposition rate in electrolytic and electrophoretic deposition processes. These parameters provide the potential for much greater process/product control compared to conventional DC deposition processes.

Mass transport in pulse current/pulse reverse current electrolytic and electrophoretic deposition processes is a combination of steady state and non-steady state diffusion processes. The mass transfer limited current density (i₁) is related to the reactant concentration gradient (C_{b}-Cₛ) and to the diffusion layer thickness (δ) by the following equation:

$${\text{i}}_{\text{p}} = - \text{nFD} {\left(\partial \text{C/} \partial \text{x}\right)}_{\text{x=0}} = - \text{nFD} \left[\left({\text{C}}_{\text{b}} - {\text{C}}_{\text{g}}\right) / δ\right]$$

where n, F, and D are the number of equivalents, Faraday’s constant, and diffusivity of the reacting species, respectively. Much of the theory of mass transport with respect to pulse electrolysis is applicable to electrophoresis. In DC electrolysis. δ is a time-invariant quantity for a given electrode geometry and hydrodynamic condition. In pulse/pulse reverse electrolysis, however, δ varies from zero at the beginning of the pulse to its steady state value when the Nemst diffusion layer is fully established. The corresponding mass transport limiting current density would then be equal to an infinite value at t = 0 and decreases to a steady state value of the DC limiting current density. The advantage of pulse/pulse reverse electrolysis is that the current can be interrupted before δ has a chance to reach steady state. This allows the reacting ions to diffuse back to the electrode surface and replenish the surface concentration to its original value before the next current interruption. Therefore, the concentration of reacting species in the vicinity of the electrode pulsates with the frequency of the modulation.

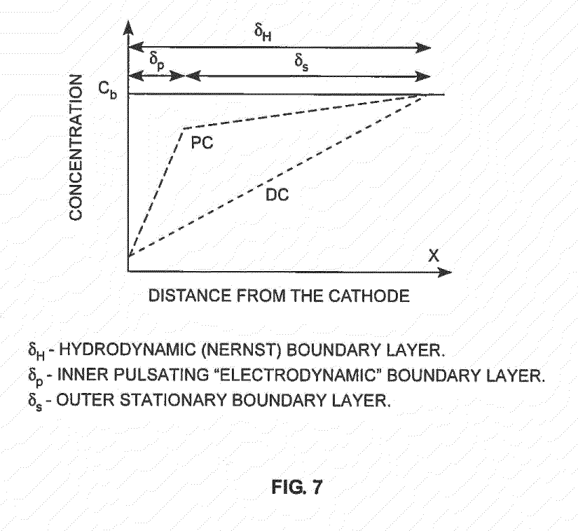

FIG. 7 illustrates the formation of a duplex diffusion layer including a pulsating layer (δp) and a stationary layer (δs) during pulse electrolysis. Since the thickness of the pulsating diffusion layer is determined by the waveform parameters, this layer may be thought of as an electrodynamic diffusion layer. By assuming a linear concentration gradient across the pulsating diffusion layer and conducting a mass balance, the pulsating diffusion layer thickness (δp) as:

$${δ}_{\text{p}} = {\left(2 {\text{Dt}}_{\text{on}}\right)}^{1 / 2}$$

where tₒₙ is the pulse on time. When the pulse on time is equal to the transition time, the concentration of reacting species at the interface drops to zero at the end of the pulse. An expression for the transition time, τ, is:

$$τ = \left({\left(\text{nF}\right)}^{2} {\text{C}}_{\text{b}} {}^{2} \text{D}\right) / 2 {\text{i}}_{\text{c}} {}^{2}$$

More exact solutions are given by integrating Fick’s diffusion equation:

$${δ}_{\text{p}} = 2 {\left(\left({\text{Dt}}_{\text{on}}\right) / π\right)}^{1 / 2}$$

$$τ = π \left({\left(\text{nF}\right)}^{2} {\text{C}}_{\text{b}} {}^{2} \text{D}\right) / 4 {\text{i}}_{\text{c}} {}^{2}$$

The same equation for the pulsating diffusion layer is also relevant to pulse reverse plating. The key points in the development of pulse current/pulse reverse current deposition processes are: (1) the electrodynamic diffusion layer thickness is proportional to the pulse on time and (2) transition time is inversely proportional to the current.

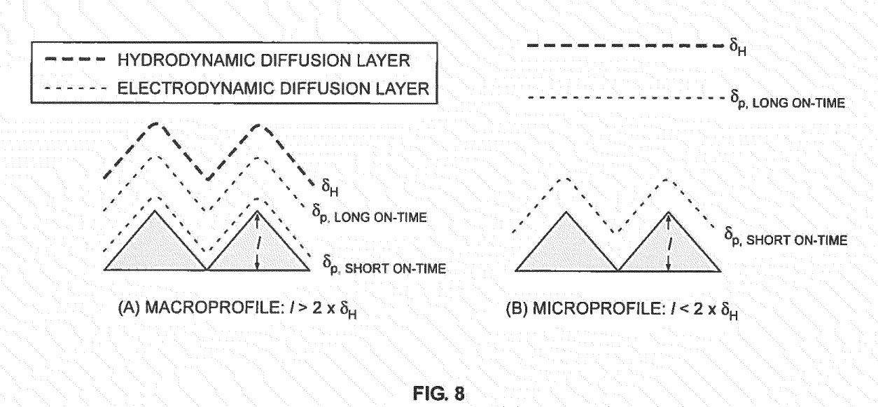

In electrolytic and electrophoretic deposition processes, deposit distribution is determined by the current distribution. The current distribution is controlled by primary (geometrical), secondary (kinetic) or tertiary (mass transport) effects. The addition of secondary or tertiary effects tends to make the current distribution more uniform, as compared to primary effects alone. If the applied waveform is designed such that the pulse on-time is much longer than the transition time, the tertiary current distribution will play an important role in the deposition. With the addition of tertiary control, the concept of macro- and micro- profiles influence the current distribution. FIG. 8a illustrates a macroprofile wherein the roughness of the surface is large compared with the thickness of the diffusion layer, and the diffusion layer tends to follow the surface contour. Under mass transport or diffusion control, a macroprofile results in a uniform current distribution or a conformal deposit during deposition. FIG. 8b illustrates a microprofile wherein the roughness of the surface is small compared with the thickness of the diffusion layer. Under mass transport control, a microprofile results in a non-uniform current distribution. By applying the appropriate waveform, one skilled in the art can effectively focus or defocus the current distribution to create non-uniform or uniform deposition respectively.

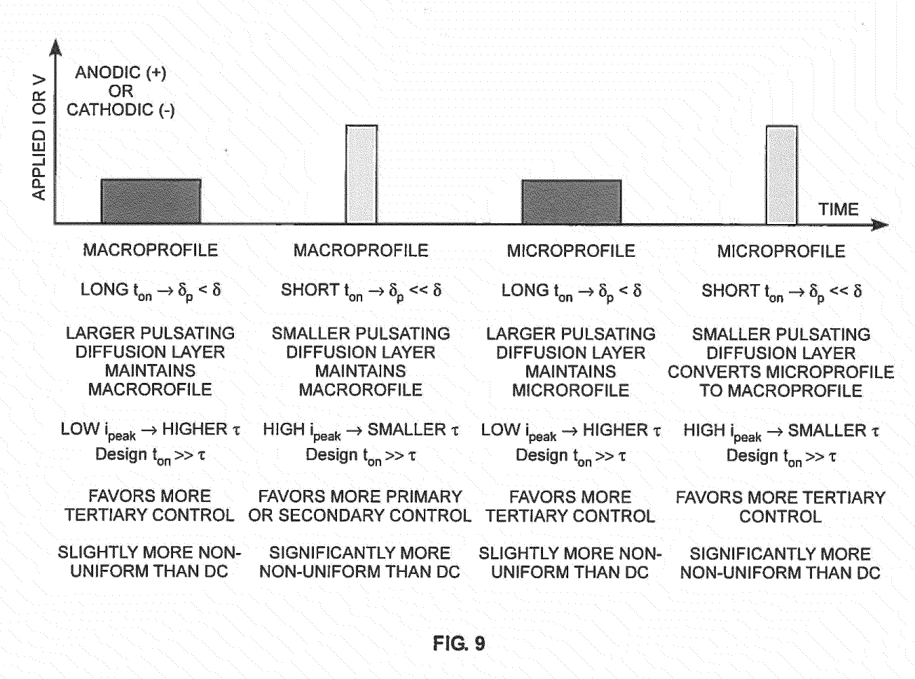

FIG. 9 summarizes four pulse current waveform types, independent of cathodic pulse or anodic pulse, to influence the current distribution and hence the deposition distribution in either an electrolytic deposition process or an electrophoretic deposition process. In some embodiments of the instant invention, a direct current is employed to deposit a multifunctional coating system. In other cases, a pulse reverse current is employed to deposit a multifunctional coating system. In other cases, a pulse reverse current is employed to deposit a multifunctional coating system. In some embodiments, a multifunctional coating system is uniformly deposited across a surface. In other embodiments, a multifunctional coating system is locally deposited across a surface.

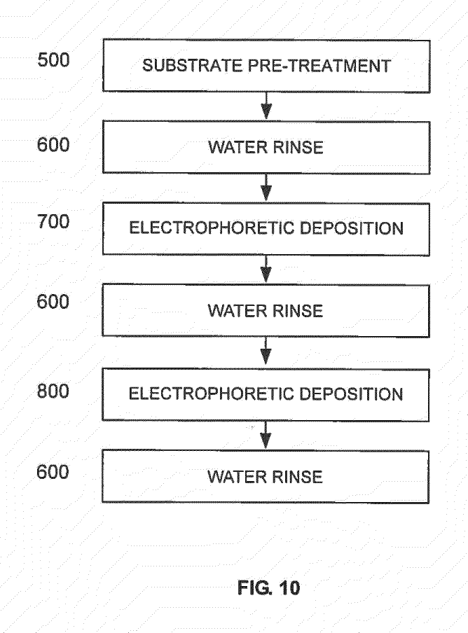

FIG. 10 depicts an embodiment of the process steps in a preferred coating deposition method. The process generally includes a substrate pre-treatment step 500 followed by a water rinse step 600. A substrate pre-treatment process for substrates that tend to form an oxide layer, such as aluminum A96061, is disclosed by the common assignee of the subject invention, U.S. Pat. Application No. 16/869,014 incorporated herein by reference. After the water rinse step 600, an electrophoretic deposition step 700 is employed to deposit one or more of the components of the multicomponent coating system followed by another water rinse step 600. In an electrolytic deposition step 800, the remaining one or more components of the multicomponent system is deposited followed by another water rinse step 600. The electrophoretic deposition step 700 may comprise one or more steps and similarly that the electrolytic deposition step 800 may comprise one or more steps. Further, the electrolytic deposition step 800 may precede the electrophoretic deposition step 800. Finally, more water rinse steps 600 may be employed or less water rinse steps 600 may be employed.

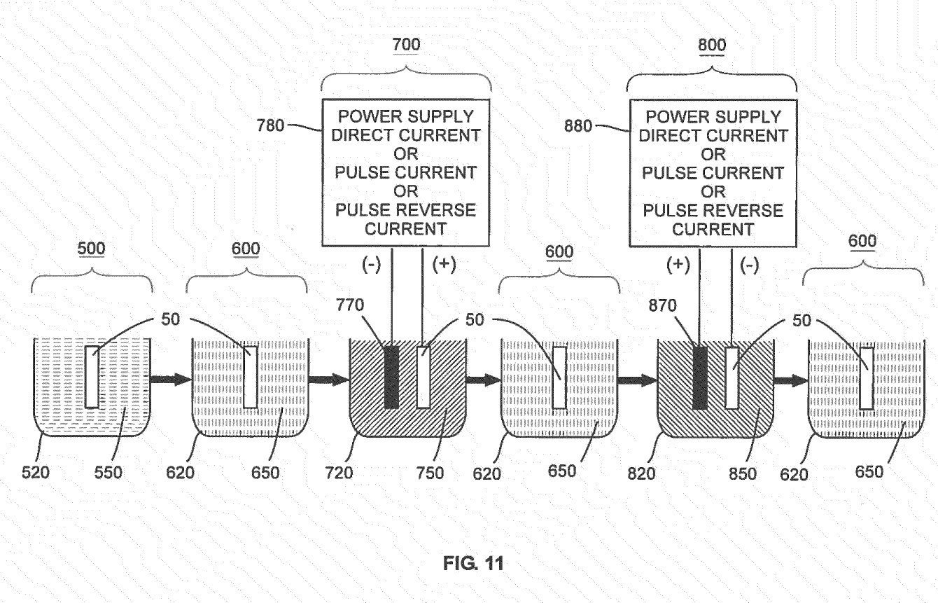

FIG. 11 depicts a process line of an embodiment of the subject method. The process line includes substrate pre-treatment step 500 with substrate 50 immersed in a pre-treatment solution 550 in cell 520. A water rinse step 600 follows wherein substrate 50 is immersed in rinse water 650 in rinse cell 620. An electrophoretic deposition step 700 follows wherein a power supply 780 is used to electrophoretically deposit one or more components of the multifunctional coating system on substrate 50. The electrophoretic cell 720 contains an electrophoretic deposition solution 750 with one or more suspended particles of the multifunctional coating system and a cathode 770. The electrophoretic deposition step is followed by another water rinse step 600. An electrolytic deposition step 800 follows wherein a power supply 880 is used to electrolytically deposit the remaining one or more components of the multifunctional coating system on substrate 50. The electrolytic cell 820 contains an electrolyte solution 850 with the one or more ions of the multifunctional coating system and an anode 870. The electrolytic deposition step 800 is followed by a water rinse step 600.

The efficacy of a substrate or coating system on a substrate to emit electrons is determined from electron yield measurements. In these measurements, a substrate or substrate with a coating system is exposed to incident electrons over a range of incident electron energies measured in electron volts (eV). The ratio of emitted electrons to incident electrons is designated as the total electron yield, σ. The total electron yield is the sum of secondary electrons and backscattered electrons. Secondary electrons are those electrons with energy less than 50 eV. Backscattered electrons are those with electrons with energy greater than 50 eV. For effective electron emission, the electron yield is greater than 1. Additionally, the substrate or substrate with a coating system should exhibit an electron yield greater than 1. Consequently, an additional measure of merit for a substrate or substrate with a coating system the maximum electron yield, σₘₐₓ and the incident electron energy where the maximum electron yield occurs, Eₘₐₓ. Another characteristic of a substrate or coating system on a substrate is the range of incident electron energies where the total electron yield is greater than 1 (σ >1 ). Another characteristic of an electron yield measurement for a substrate or substrate with a coating system is the initial incident electron energy, Eᵢₙᵢₜᵢₐₗ, where the total electron yield is greater than one (σ > 1) and the final incident electron energy, E_{final} where the total electron yield is greater than one (σ > 1). Another measure of merit for a substrate and substrate with a coating system is the range of incident electron energies. Δ_{(σ>1)} where the total electron yield is greater than one (σ > 1).

The following examples illustrate various embodiments of the instant method.

### Working Example I

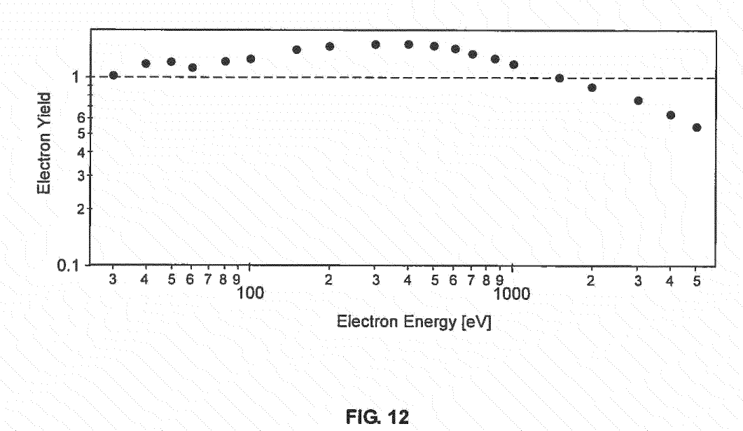

In FIG. 12 the electron yield data for an aluminum A96061 coupon without a coating system are presented. The A96061 coupon was grit-blasted prior to the measurements. The grit blast media consisted of 80 grit alumina particles. The surface roughness of the A96061 substrate was 0.18 µm prior to grit blasting and 1.01 µm after grit blasting. The data from the electron yield measurements are summarized in TABLE I. The aluminum A96061 substrate without a coating system exhibited a σₘₐₓ of 1.50 ± 0.05 at an Eₘₐₓ of 320 ± 20 keV with initial electron energy with total electron yield greater than one (Eᵢₙᵢₜᵢₐₗ) of 26 ± 4 keV, a final electron energy with total electron yield greater than one (E_{final}) of 1500 ± 50 keV and a range of incident electron energies with a total electron yield greater than one (Δ_{(σ>1)}) of 1474 keV.

Table I

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>1)} (keV) |
| Grit Blasted A1 Substrate | N/A | 1.50 ± 0.05 | 320 ± 20 | 26 ± 4 | 1500 ± 50 | 1474 |

### Working Example II

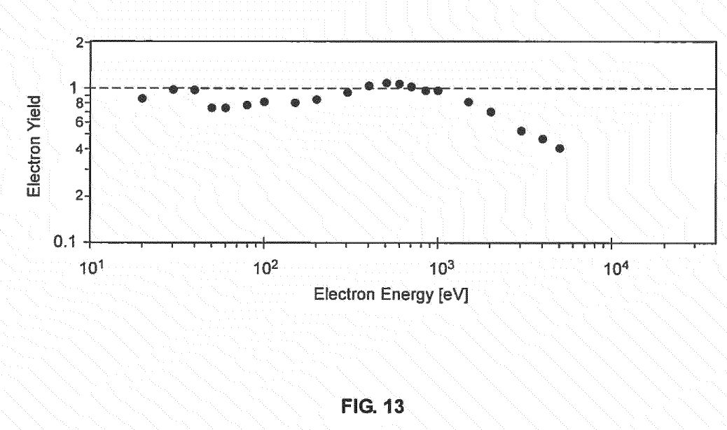

In FIG. 13, the electron yield data for an aluminum A96061 coupon with a boron-doped diamond (BDD) coating system prepared with a single deposition step are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. The boron-doped diamond particles were electrophoretically deposited from an electrophoretic solution consisting of boron-doped diamond particles of 5 µm size (Engis Corporation, IL, USA) suspended with a binder (e.g., polyvinyl pyrrolidone (PVP), Molecular Weight of 2,500) in ethanol at a concentration of 1:0.5 BDD/PVP weight ratio. The coating system was electrophoretically deposited in a one-step deposition method. The electrophoretic deposition step was conducted at a temperature of 25° C. In the electrophoretic deposition cell, the aluminum A96061 substrate was separated from the cathode by approximately 2.5 cm. The direct current (DC) voltage applied to the electrophoretic deposition cell was 100 V for a time of 30 min. The data from the electron yield measurements are summarized in TABLE II. The aluminum A96061 substrate with boron-doped diamond (BDD) coating system exhibited a σₘₐₓ of 1.06 ± 0.03 at an Eₘₐₓ of 545 ± 30 keV with an initial electron energy with total electron yield greater than one (Eᵢₙᵢₜᵢₐₗ) of 360 ± 30 keV, a final electron energy with total electron yield greater than one (E_{final}) of 740 ± 50 keV and a range of incident electron energies with total electron yield greater than one (Δ_{(σ>1)}) of 380 keV.

Table II

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>1)} (keV) |
| BDD + PVP | One Step (Electrophoretic Deposition) | 1.06 ± 0.03 | 545 ± 30 | 360 ± 30 | 740 ± 50 | 380 |

### Working Example III

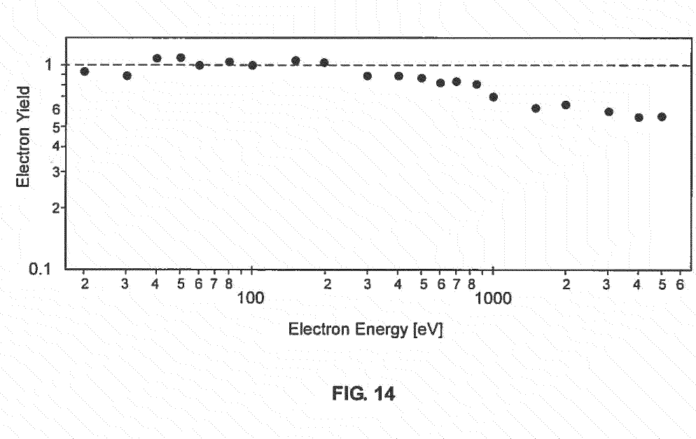

In FIG. 14 the electron yield data for an aluminum A96061 coupon with a lanthanum hexaboride (LaB₆) coating system prepared with a single deposition step are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. The lanthanum hexaboride (LaB₆) particles were electrophoretically deposited from an electrophoretic solution consisting of lanthanum hexaboride (LaB₆) particles of 80 nm in size (purchased from ALB Materials Inc, NV, USA) suspended in ethanol at a concentration of 0.2 weight%. The coating system was electrophoretically deposited in a one-step deposition method. The electrolytic deposition step was conducted at a temperature of 25° C. In the electrophoretic deposition cell, the aluminum A96061 substrate was separated from the cathode by approximately 2.5 cm. The direct current (DC) voltage applied to the electrophoretic deposition cell was 300 V for a time of 30 min. The data from the electron yield measurements are summarized in TABLE III. The aluminum A96061 substrate with lanthanum hexaboride (LaB₆) coating system exhibited a σₘₐₓ of 1.45 ± 0.2 at an Eₘₐₓ of 420 ± 50 keV with an initial electron energy with total electron yield greater than one (Eᵢₙᵢₜᵢₐₗ) of 38 ± 2 keV, a final electron energy with total electron yield greater than one (E_{final}) of 1050 ± 50 keV and a range of incident electron energies with total electron yield greater than one (Δ_{(σ>1)}) of 1012 keV.

Table III

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} | Δ_{(σ>1)} (keV) |
| LaB_{σ} | One Step (Electrophoretic Deposition) | 1.45 ± 0.2 | 420 ± 50 | 38 ± 2 | 1050 ± 50 | 1012 |

### Working Example IV

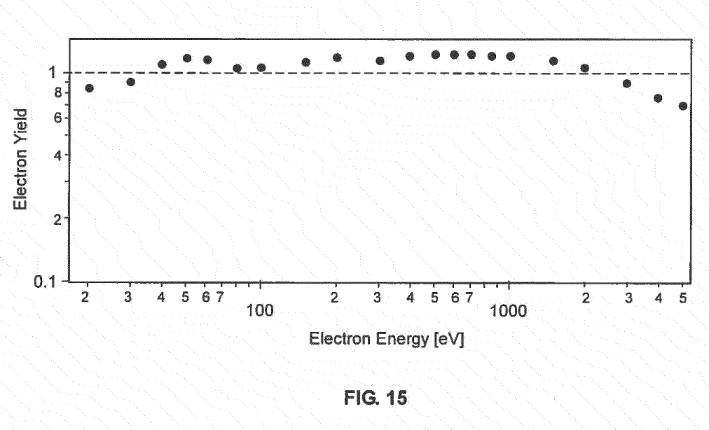

In FIG. 15 the electron yield data for an aluminum A96061 coupon with a cerium hexaboride (CeB₆) coating system prepared with a single deposition step are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. The cerium hexaboride (CeB₆) particles were electrophoretically deposited from an electrophoretic solution consisting of cerium hexaboride (CeB₆) particles of 10 µm size suspended in ethanol at a concentration of 0.2 weight%. The coating system was electrophoretically deposited in a one-step deposition method. The electrolytic deposition step was conducted at a temperature of 25° C. In the electrophoretic deposition cell, the aluminum A96061 substrate was separated from the cathode by approximately 2.5 cm. The direct current (DC) voltage applied to the electrophoretic deposition cell was 300 V for a time of 30 min. The data from the electron yield measurements are summarized in TABLE IV. The aluminum A96061 substrate with cerium hexaboride (CeB₆) coating system exhibited a σₘₐₓ of 1.40 ± 0.2 at an Eₘₐₓof 650 ± 10 keV with an initial electron energy with total electron yield greater than one (Eᵢₙᵢₜᵢₐₗ of 35 ± 5 keV, a final electron energy with total electron yield greater than one (E_{final}) of 2300 ± 50 keV and a range of incident electron energies with total electron yield greater than one (Δ_{(σ>1}) of 2265 keV.

Table IV

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>1)} (keV) |
| CeB_{σ} | One Step (Electrophoretic Deposition) | 1.40 ± 0.2 | 6.50 ± 10 | 35 ± 5 | 2300 ± 50 | 2265 |

### Working Example V

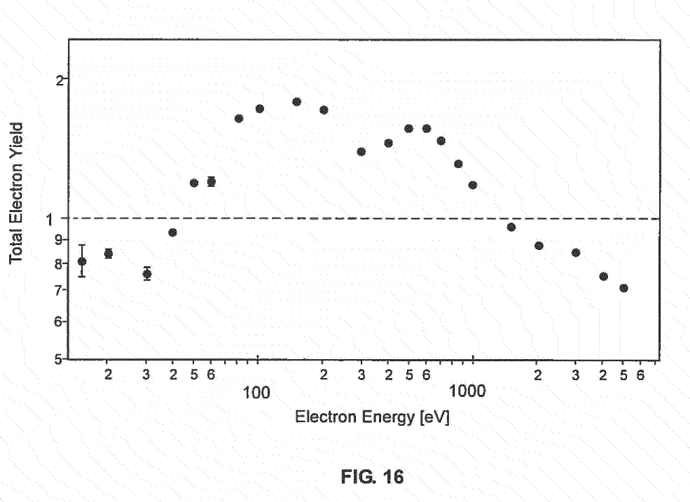

In FIG. 16 the electron yield data for an aluminum A96061 coupon with a calcium hexaboride (CaB₆) coating system prepared with a single deposition step are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. The calcium hexaboride (CaB₆) particles were electrophoretically deposited from an electrophoretic solution consisting of calcium hexaboride (CaB₆) particles of 10 µm size (procured from Stanford Advanced Materials, CA, USA) suspended in ethanol at a concentration of 0.2 weight%. The coating system was electrophoretically deposited in a one-step deposition method. The electrolytic deposition step was conducted at a temperature of 25° C. In the electrophoretic deposition cell, the aluminum A96061 substrate was separated from the cathode by approximately 2.5 cm. The direct current (DC) voltage applied to the electrophoretic deposition cell was 300 V for a time of 30 min. The data from the electron yield measurements are summarized in TABLE V. The aluminum A96061 substrate with calcium hexaboride (CaB₆) coating system exhibited a σₘₐₓ of 1.70 ± 0.2 at an Eₘₐₓ of 300 ± 10 keV with an initial electron energy with total electron yield greater than one (Eᵢₙᵢₜᵢₐₗ) of 43 ± 5 keV, a final electron energy with total electron yield greater than one (E_{final}) of 1050 ± 50 keV and a range of incident electron energies with total electron yield greater than one (Δ_{(σ>l)}) of 1007 keV.

Table V

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>l)} (keV) |
| CaB_{σ} | One Step (Electophoretic Deposition) | 1.70 ± 0.2 | 300 ± 10 | 43 ±5 | 1050 ± 50 | 1007 |

### Working Example VI

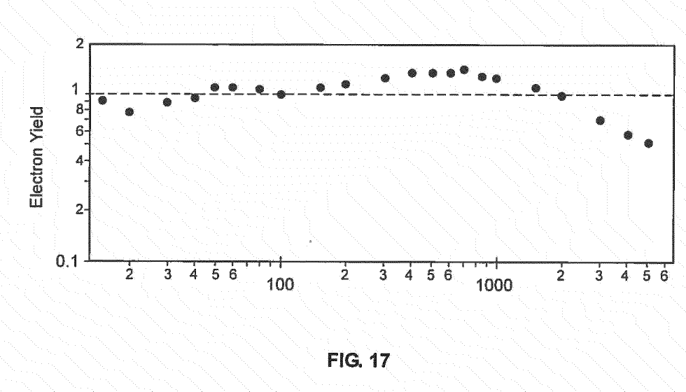

In FIG. 17 the electron yield data for an aluminum A96061 coupon with a two-layer coating system consisting of boron-doped diamond (BDD) with lithium (Li) prepared with two deposition steps are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. In the first deposition step, the boron-doped diamond particles were electrophoretically deposited from an electrophoretic solution consisting of boron-doped diamond particles of 5 µm size (Engis Corporation, IL, USA), with a polyvinyl pyrrolidone (PVP, Molecular Weight of 2,500) in isopropanol at a concentration of 1:0.5 BDD/PVP weight ratio. The electrophoretic deposition step was conducted at a temperature 25° C. In the electrophoretic deposition cell, the aluminum A96061 substrate was separated from the cathode by approximately 2.5 cm. The direct current (DC) voltage applied to the electrophoretic deposition cell was 100 V for a time of 30 min. In the second deposition step, lithium was electrolytically deposited from an electrolyte solution within an argon-filled glovebox. The electrolyte solution contained 1 M LiPF₆ in ethylene carbonate-ethyl methyl carbonate (EC:EMC) (3:7 vol) and lithium metal was used as the counter/reference. The electrolytic deposition step was conducted at a temperature of 25° C. In the electrolytic deposition cell, the aluminum A96061 substrate coated with boron-doped diamond coating was separated from the cathode by approximately ⅜ inch. The direct current (DC) voltage applied to the electmdeposition cell was 10 V for a time of 10 sec. By conducting the electrophoretic deposition step followed by the electrolytic deposition step, the two layered coating system consisted of a first layer of boron-doped diamond and a second layer of boron-doped diamond decorated with lithium. The data from the electron yield measurements are summarized in TABLE VI. The aluminum A96061 substrate with a multilayer coating system consisting of boron-doped diamond (BDD) with lithium (Li) exhibited a σₘₐₓ of 1.40 ± 0.2 at an Eₘₐₓ at 300 ± 10 keV with an initial electron energy with total electron yield greater than one (Eᵢₙᵢₜᵢₐₗ) of 45 ± 5 keV, a final electron energy with total electron yield greater than one (E_{final}) of 1900 ± 50 keV and a range of incident electron energies with total electron yield greater than one (Δ_{(σ>1)}) of 1855 keV.

Table VI

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>l)} (keV) |
| Li enhanced BDD | Two Step (Electrophoretic + Electrolytic Deposition) | 1.40 ± 0.2 | 750 ± 20 | 45 ± 5 | 1900 ± 50 | 1855 |

### Working Example VII

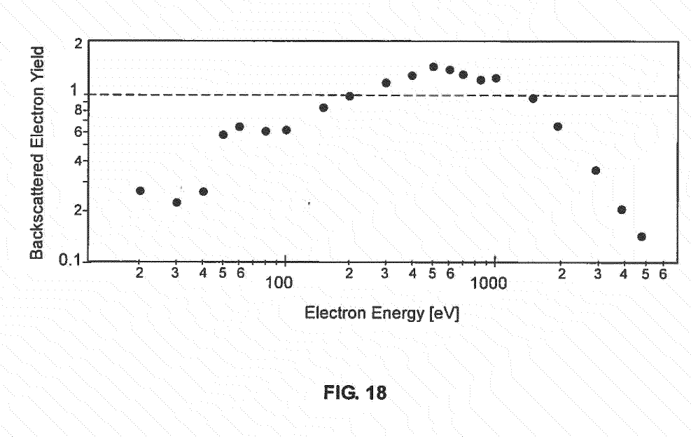

In FIG. 18 the electron yield data for an aluminum A96061 coupon with a three-layer coating system consisting of boron-doped diamond (BDD), graphene and lithium (Li) prepared with three deposition steps are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. In the first deposition step, the boron-doped diamond particles were electrophoretically deposited from an electrophoretic solution consisting of boron-doped diamond particles of 5 µm size (Engis Corporation, IL, USA), with a polyvinyl pyrrolidone (PVP, Molecular Weight of 2,500) in isopropanol at a concentration of 1:0.5 BDD/PVP weight ratio. The electrophoretic deposition step was conducted at a temperature 25° C. In the electrophoretic deposition cell, the aluminum A96061 substrate was separated from the cathode by approximately 2.5 cm. In the second deposition step, the graphene particles were electrophoretically deposited from an electrophoretic solution consisting of graphene oxide particles as powder (15-20 sheets, Sigma Aldrich, MO, USA) suspended at a concentration of 0.2 weight% in electrolyte containing 1 M NaOH, and isopropanol. The electrophoretic deposition step was conducted at a temperature 25° C. In the electrophoretic deposition cell, the aluminum A96061 substrate was separated from the cathode by approximately 2.5 cm. The direct current (DC) voltage applied to the electrophoretic deposition cell was 100 V for a time of 30 min. In the third deposition step, lithium was electrolytically deposited from an electrolyte solution within an argon-filled glovebox. The electrolyte solution contained1 M LiPF₆ in ethylene carbonate-ethyl methyl carbonate (EC:EMC) (3:7 vol) and lithium metal was used as the counter/reference. The electrolytic deposition step was conducted at a temperature of 25° C. In the electrolytic deposition cell, the aluminum A96061 substrate coated with boron-doped diamond coating was separated from the cathode by approximately ⅜ inch. The direct current (DC) voltage applied to the electrodeposition cell was 2 V for a time of 10 sec. By conducting the first electrophoretic deposition step followed by a second electrophoretic deposition followed by an electrolytic deposition step, the three-layered coating system consisted of a first layer of boron-doped diamond and a second layer of boron-doped diamond decorated with lithium. The data from the electron yield measurements are summarized in TABLE VII. The aluminum A96061 substrate with a multilayer coating system consisting of boron-doped diamond (BDD) with lithium (Li) exhibited a σₘₐₓ of 3.15 ± 0.2 at an Eₘₐₓ at 370 ± 20 keV with an initial electron energy with total electron yield greater than one (Eᵢₙᵢₜₐₗ) of 45 ± 5 keV, a final electron energy with total electron yield greater than one (E_{final}) of 3300 ± 50 keV and a range of incident electron energies with total electron yield greater than one (Δ_{(σ>l)}) of 3255 keV.

Table VII

| Sample ID | coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>l)} (keV) |
| Li enhanced BDD/Graphe ne layers | Three Step (Two Electrophoretíc+ Electrolytíc Deposition) | 3.15 ± 0.2 | 370 ± 20 | 45 ± 5 | 3300 ± 50 | 3255 |

### Working Example VIII

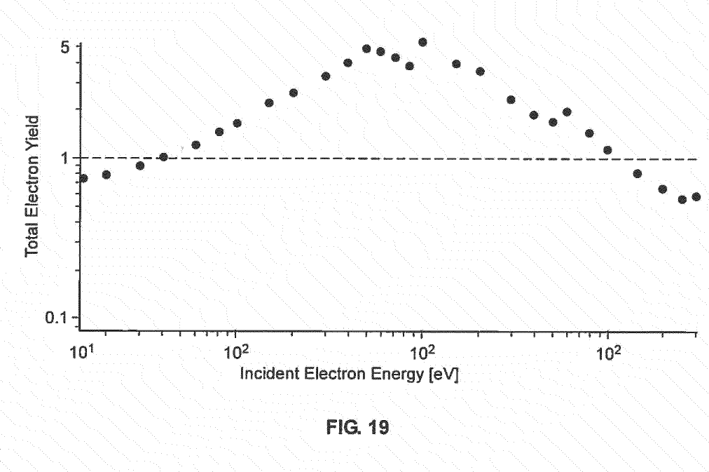

In FIG. 19 the electron yield data for an aluminum A96061 coupon with a two-layer coating system consisting of graphene and lithium (Li) prepared with two deposition steps are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. In the first deposition step, the graphene particles were electrophoretically deposited from an electrophoretic solution consisting of graphene oxide particles as powder ( 15-20 sheets, Sigma Aldrich, MO, USA) suspended in isopropanol and 1 M NaOH mixture with a polyvinyl pyrrolidone (PVP, Molecular Weight of 2500) at a concentration of 0.2 weight%. The electrophoretic deposition step was conducted at a temperature 25° C. In the electrophoretic deposition cell, the aluminum A96061 substrate was separated from the cathode by approximately 2.5 cm. The direct current (DC) voltage applied to the electrophoretic deposition cell was 100 V for a time of 30 min. In the second deposition step, lithium was electrolytically deposited from an electrolyte solution. The electrolyte solution contained 1 M LiPF₆ in ethylene carbonate-ethyl methyl carbonate (EC:EMC) (3:7 vol) and lithium metal was used as the counter/reference. The electrolytic deposition step was conducted at a temperature of 25° C. In the electrolytic deposition cell, the aluminum A96061 substrate coated with boron-doped diamond coating was separated from the cathode by approximately ⅜ inch. The direct current (DC) voltage applied to the electrodeposition cell was 2 V for a time of 10 sec. By conducting the electrophoretic deposition step followed by an electrolytic deposition step, the two layered coating system consisted of a first layer of boron-doped diamond and graphene and a second layer of boron-doped diamond and graphene decorated with lithium. The data from the electron yield measurements are summarized in TABLE VIII. The aluminum A96061 substrate with a multilayer coating system consisting of boron-doped diamond (BDD) with lithium (Li) exhibited a σₘₐₓ of 3.6 ± 0.2 at an Eₘₐₓ at 520 ± 30 keV with an initial electron energy with total electron yield greater than one (Eᵢₙᵢₜᵢₐₗ) of 31 ± 5 keV, a final electron energy with total electron yield greater than one (E_{final}) of 6000 ± 50 keV and a range of incident electron energies with total electron yield greater than one (Δ_{(σ>l)}) of 5969 keV.

Table VIII

| Sample ID | Coating Preparation Method | Total Electron Yield (TEY) | | | | |
|---|---|---|---|---|---|---|
| | | σₘₐₓ | Eₘₐₓ (keV) | Eᵢₙᵢₜᵢₐₗ keV) | E_{final} (keV) | Δ_{(σ>l)} (keV) |
| Li enhanced layer | Two Step (Electrophoretic + Electrolytic Deposition) | 6.2 ± 0.3 | 800 ± 50 | 43+4 | 9600 + 100 | 9557 |

### Working Example IX

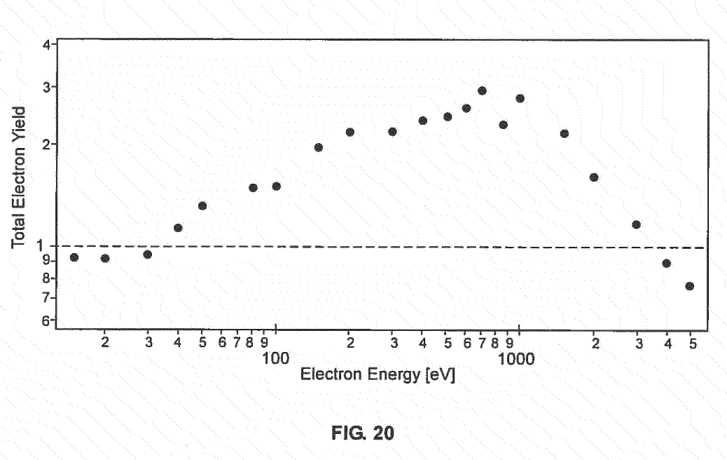

In FIG. 20 the electron yield data for an aluminum A96061 coupon with a two-layer coating system consisting of boron-doped diamond (BDD), graphene and lithium (Li) prepared with two deposition steps are presented. The A96061 coupon was grit blasted prior to the deposition of the coating system. The grit blast media consisted of 80 grit alumina particles. The surface roughness of the A96061 substrate was 0.18 µm prior to grit blasting and 1.01 µm after grit blasting. In the first deposition step, the boron-doped diamond particles and graphene particles were electrophoretically deposited from an electrophoretic solution consisting of boron-doped diamond particles of 5 µm size 0.2 weight % (Engis Corporation, IL, USA) and 0.2 weight % graphene oxide particles as powder (15-20 sheets, Sigma Aldrich, MO, USA) suspended in isopropanol and 1 M NaOH mixture with a polyvinyl pyrrolidone (PVP, Molecular Weight of 2500, 1:0.5 weight ratio to BDD) at a concentration of 0.2 weight%. The electrophoretic deposition step was conducted at a temperature 25° C. In the electrophoretic deposition cell, the aluminum A96061 substrate was separated from the cathode by approximately 2.5 cm. The direct current (DC) voltage applied to the electrophoretic deposition cell was 100 V for a time of 30 min. In the second deposition step, lithium was electrolytically deposited from an electrolyte solution. The electrolyte solution contained1 M LiPF₆ in ethylene carbonate-ethyl methyl carbonate (EC:EMC) (3:7 vol) and lithium metal was used as the counter/reference. The electrolytic deposition step was conducted at a temperature of 25° C. In the electrolytic deposition cell, the aluminum A96061 substrate coated with boron-doped diamond coating was separated from the cathode by approximately ⅜ inch. The direct current (DC) voltage applied to the electrodeposition cell was 2 V for a time of 10 sec. By conducting the electrophoretic deposition step followed by an electrolytic deposition step, the two layered coating system consisted of a first layer of boron-doped diamond and graphene and a second layer of boron-doped diamond and graphene decorated with lithium. The data from the electron yield measurements are summarized in TABLE IX. The aluminum A96061 substrate with a multilayer coating system consisting of boron-doped diamond (BDD) with lithium (Li) exhibited a σₘₐₓ of 3.6 ± 0.2 at an Eₘₐₓ at 520 ± 30 keV with an initial electron energy with total electron yield greater than one (Eᵢₙᵢₜᵢₐₗ) of 31 ± 5 keV, a final electron energy with total electron yield greater than one (E_{final}) of 6000 ± 50 keV and a range of incident electron energies with total electron yield greater than one (Δ_{σ>l)}) of 5969 keV.

Table IX

| Sample ID | Preparation Method | Total Electron Yield (TEY) | | | | |
|---|---|---|---|---|---|---|
| | | σₘₐₓ | Eₘₐₓ (keV) | Eᵢₙᵢₜᵢₐₗ (keV) | E_{final} (keV) | Δ_{(σ>l)} |
| Li enhanced BDD Graphene mixture | Two Step (Electophoretic + Electrolytic Deposition) | 3.6 ± 0.2 | 520 ± 30 | 31 ± 5 | 6000 ± 50 | 5969 |

### Working Example X

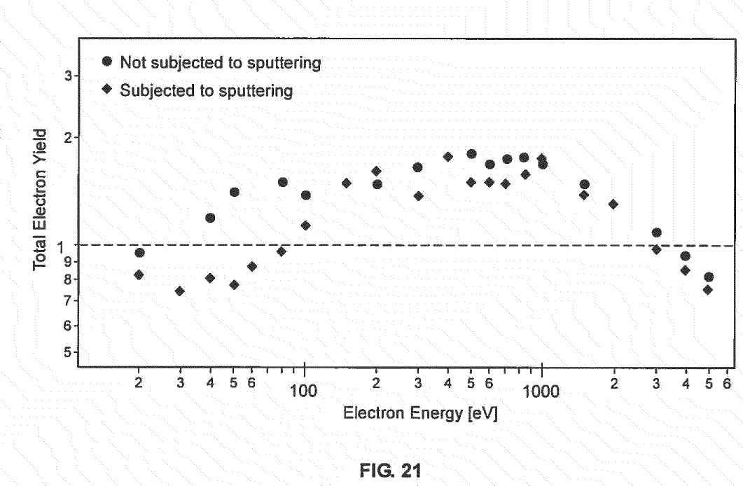

Electron yield measurements for an aluminum A96061 coupon with a two-layer coating system prepared with two deposition steps consisting of boron-doped diamond (BDD), graphene and lithium (Li) were measured before and after erosion exposure. The coating system was prepared in the same manner as described in EXAMPLE IX. The sample was exposed to sputtering in an argon plasma as a measure of the erosion resistance of the coating system. The conditions of the argon sputtering test represented an aggressive erosion test compared to typical space environment ion fluences. The plasma was generated with a hollow cathode plasma ion gun source (VGMicrotech Model AG5000) to create a low-density (10⁶ /cm³), low-temperature (≤1-eVelectron temperature) plasma. The ion sputter gun beam has an energy range of 0.3 to 5 keV, with typical maximum currents of 10 µA at 0.5 keV and 40 µA at 5 keV. The ion beam was at an incidence angle of 60° from normal. Sputtering for this test used a 5 keV ion beam of argon with an approximate current density of 500 nA/cm², a particle flux of 10¹¹ Ar atom/cm²-s, and an energy flux of -2.5 mW/cm². The sample was exposed to the ion beam for 60±1 min with an approximate 30% duty cycle. The estimated fluence for the test was -500 µC/cm² or 7×10²⁰ argon atoms/cm². The total energy fluence for the test was 0.5 MW/cm². The operating pressure was elevated to approximately 5×10⁻⁶ Torr residual argon pressure during sputtering. The use of 5×10⁻⁶ Torr residual argon pressure acts to dissipate the charge deposited by the electron beam during the electron yield measurements. Consequently, to provide a meaningful comparison, electron yield measurements on a coating system not subjected to sputtering were corrected for charge dissipation. The electron yield data for the two-layer coating system are presented in FIG. 21 before and after being subjected to the erosion conditions. The data are presented in TABLE X. Generally, the electron yield of the coating system subjected to sputtering is similar to the coating system not subjected to sputtering at energies above 100 eV. The difference in the electron yield data below 100 eV is attributed to the high residual argon gas pressure (5×10⁻⁶ Torr). Specifically, the low incident energy electrons are appreciably scattered by the residual argon atmosphere within the vacuum chamber. Consequently, the number of electrons reaching the detector at energies below 100 eV are reduced and the measured electron yield below 100 eV is reduced.

Table X

| Sample ID | Preparation Method -EXAMPLE IX | Total Electron Yield (TEY) | | | | |
|---|---|---|---|---|---|---|
| | | σₘₐₓ | Eₘₐₓ | Eᵢₙᵢₜᵢₐₗ (keV) | E_{final} (keV) | Δ_{(σ>l)} |
| Li enhanced BDD Graphene mixture | NOT Subjected to Argon Sputtering | 1.77 | 620 | 31 | 3250 | 3219 |
| Li enhanced BDD Graphene mixture | SUBJECTED to Argon Sputtering | 1.72 | 590 | 82 | 2950 | 2868 |

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A method of coating a substrate, the method comprising:
adding ion erosion resistant particles, conductive particles, and a binder to an electrophoretic solution in an electrophoretic deposition apparatus including the substrate and a cathode spaced from the substrate;
applying a current to the substrate and cathode to deposit a first layer coating including the erosion resistant particles, the conductive particles, and the binder onto the substrate;
adding a low work function material to an electrolyte solution in an electrolytic deposition apparatus including the substrate and a cathode spaced from the substrate; and
applying a current to the substrate and the cathode to deposit a second layer coating including the low work function material onto the substrate.

2. The method of claim 1 in which the erosion resistant particles include boron doped diamond particles.

3. The method of claim 1 in which the conductive particles include graphene, carbon nanotubes, and/or carbon black.

4. The method of claim 1 in which the low work function material includes lithium, calcium hexaboride, cerium hexaboride, and/or lanthanum hexaboride.

5. The method of claim 1 in which the second layer coating includes the erosion resistant particles, the conductive particles, and the low work function material.

6. The method of claim 1 further including removing any oxide on the substrate before placing the substrate in the electrophoretic deposition apparatus.

7. The method of claim 1 in which the substrate is aluminum.

8. A substrate coated with a two-layer coating comprising:
a first electrophoretically deposited layer including ion erosion resistant particles, conductive particles, and a binder prevent ion erosion and to provide atomic oxygen shielding; and
a second electrolytically deposited layer including a low work function material to improve passive electron emissivity.

9. The method of claim 8 in which the erosion resistant particles include boron doped diamond particles.

10. The method of claim 8 in which the conductive particles include graphene, carbon nanotubes, and/or carbon black.

11. The method of claim 8 in which the low work function material includes lithium, calcium hexaboride, cerium hexaboride,and/or lanthanum hexaboride.

12. The method of claim 8 in which the second deposited layer includes the erosion resistant particles, the conductive particles, and the low work function material.

13. The method of claim 8 in which the substrate is aluminum.

14. A method of coating a substrate, the method comprising:
employing an electrophoretic process to deposit ion erosion resistant particles, conductive particles, and/or a low work function material onto a substrate; and
employing an electrolytic process to deposit ion erosion resistant particles, conductive particles, a binder, and/or a low work function material onto the substrate.

15. The method of claim 14 electrophoretic process is carried out before the electrolytic process.

16. The method of claim 14 in which the electrophoretic process is employed to deposit the ion erosion resistant particles, and the conductive particles, and the electrolytic process is employed to deposit the low work function material.

17. The method of claim 14 in which a binder is included in the electrophoretic process.
